(19) United States
(12) Patent Application Publication
(10) Pub. No.: US 2019/0118694 A1
(43) Pub. Date: Apr. 25, 2019

(54) Boat-Lift Moving Suspension System

(71) Applicant: Clayton Melrose, Oakes, ND (US)

(72) Inventor: Clayton Melrose, Oakes, ND (US)

(21) Appl. No.: 16/220,644

(22) Filed: Dec. 14, 2018

Related U.S. Application Data
(63) Continuation-in-part of application No. 15/986,783, filed on May 22, 2018, now abandoned.
(60) Provisional application No. 62/603,263, filed on May 22, 2017.

(51) Int. Cl. B60P 3/10; B63C 3/06; B63B 27/16

(52) U.S. Cl. CPC B60P 3/1091; B63B 27/16; B63C 3/06

(57) ABSTRACT

A lift assembly comprises a frame work extending between a first lift side and a second lift side and a frame support system wherein a portion of the frame support system includes a ski system that extends under the frame work in the direction of travel such that a continuous sliding surface is presented to slide the frame over obstacles.

### CROSS-REFERENCE TO RELATED APPLICATIONS

This application is a continuation in part of application Ser. No. 15/986,783 filed May 22, 2018 which claims priority to Provisional Application No. 62/603,263 filed May 22, 2017.

### STATEMENT REGARDING FEDERALLY SPONSORED RESEARCH

Not Applicable

### FIELD OF THE INVENTION

This invention relates to an improved boat lift.

### BACKGROUND OF THE INVENTION

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Boat lifts are often moved when they are deployed adjacent to docks in the Spring of the year and when they are removed from the water in the Fall before freeze up. To use wheels or a raised leading edge on the leg support pads to increase the height at which obstacles that can be traversed is not particularly effective. These strategies have performance limitations and maintenance problems that result in sometimes requiring the replacement of the wheels or pads. When a lift is being moved, pads under the legs of the lift sometime catch uneven topography or obstacles and break off. Many wheels used on lifts are plastic units that are often replaced when they break, freeze, or otherwise self-destruct. Wheels have their own set of problems because servicing a broken tire wheel combination is seldom practical.

A boatlift system that facilitates moving a boat lift across more rugged ground without building ramps or lifting leg pads over obstacles that may otherwise tear off the pads is a desirable need. The instant invention accomplishes this in part by moving boat lifts into or out of the water by moving them across the lake bed and ground surface through means of a ski under a boat lift support leg with one raised end facing the direction of travel. The raised outboard end of each ski has an opening to accommodate tow lines passing through them so the line pulled over an obstacle raises the ski end helping it start to slide over the top of the encountered obstacle. The opposite end of the ski can then follow the leg over the obstacle as it continuous to slide to the ski's end which is attached toward the center of the lift's lower beam. The beam itself acts as a slide surface between the skis. The rear leg ski is a mirrored ski similar or identical to the front ski providing a continuous ski surface from the front tow line to the rear of the back ski which extends beyond the lift frame. The function is identical if towed from either end. Four skis provide for left and right continuous slide surfaces that can slide over obstacles that would normally prevent passage of the lift without using ramps or a vertical lifting device.

The art referred to and/or described within this application is not intended to constitute an admission that any patent, publication or other information referred to herein is “prior art” with respect to this invention. In addition, this section should not be construed to mean that a thorough search has been made or that no other pertinent information as defined in 37 C.F.R. § 1.56(a) exists.

All US patents and applications and all other published documents mentioned anywhere in this application are incorporated herein by reference in their entirety. U.S. Pat. No. 9,930,432 is incorporated herein by reference in its entirety.

Without limiting the scope of the invention, a brief summary of some of the claimed embodiments of the invention is set forth below. Additional details of the summarized embodiments of the invention and/or additional embodiments of the invention may be found in the Detailed Description of the Invention below.

A brief abstract of the technical disclosure in the specification is provided as well, only for the purposes of complying with 37 C.F.R. 1.72. The abstract is not intended to be used for interpreting the scope of the claims.

### BRIEF SUMMARY OF THE INVENTION

In at least one embodiment of the invention, a lift assembly can comprise a frame work extending between a first lift side and a second lift side and a frame support system wherein a portion of the frame support system includes a ski system that extends under the frame work in the direction of travel such that a continuous sliding surface is presented to slide the frame over obstacles.

In at least one embodiment of the lift assembly the end of the ski toward the direction of travel engages a tow line. The tow line can be constructed and arranged to provide lift to the ski end when the tow line is pulled. The tow line in some embodiments can lift the ski end over obstacles higher than the ski height which would otherwise not be able to be traversed

In at least one embodiment, a member of the frame support system at a lower position of the frame support system can function as part of the ski sliding surface in conjunction with a ski segment at each end to form a continuous surface under the lift.

In at least one embodiment, the end of the ski toward the direction of travel engages the tow line to lift the ski end over obstacles higher than the ski height which would otherwise not be able to be traversed.

In at least one embodiment, a plurality of wheels are installed.

These and other embodiments which characterize the invention are pointed out with particularity in the claims annexed hereto and forming a part hereof. However, for further understanding of the invention, its advantages and objectives obtained by its use, reference should be made to the drawings which form a further part hereof and the accompanying descriptive matter, in which there is illustrated and described embodiments of the invention.

### BRIEF DESCRIPTION OF THE SEVERAL VIEWS OF THE DRAWING(S)

A detailed description of the invention is hereafter described with specific reference being made to the drawing.

FIG. 1 is a perspective view of a ski set on one side of a boat-lift frame bottom.

FIG. 2 is a perspective view of a ski set on one side of a boat-lift frame bottom.

FIG. 3 is a perspective view of a ski set on a two wheel boat-lift frame with one wheel shown and one wheel removed showing the boat lift portion.

### DETAILED DESCRIPTION OF THE INVENTION

While this invention may be embodied in many different forms, there are described in detail within the specification specific preferred embodiments of the invention. This description is an exemplification of the principles of the invention and is not intended to limit the invention to the particular embodiments illustrated.

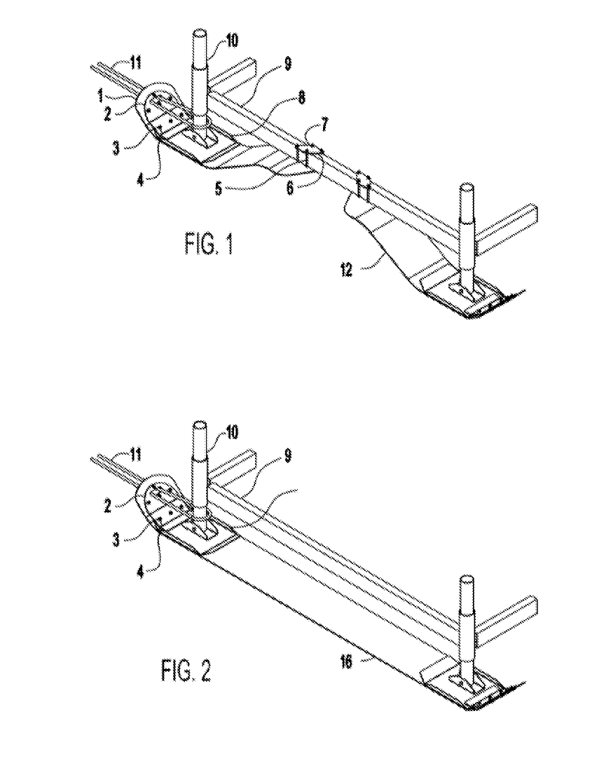

FIG. 1 illustrates the invented ski system on one side of the bottom frame of a boat lift. One of the pertinent frame parts of an existing boat lift shown in FIG. 1 includes the side bottom beam 9. The lift can be supported from ground level by legs 10 that sit on load bearing leg pads 8. The height of pad 8 can be made adjustable with respect to beam 9 to set the level and height of the boat lift with respect to the water surface with uneven lake beds beneath the lift. Existing pads 8 can allow boat lifts to slide forward or backward in the direction of the length of beam 9. This generally works better when the ground and sand beneath the pads is smooth and free of ridges or other obstructions.

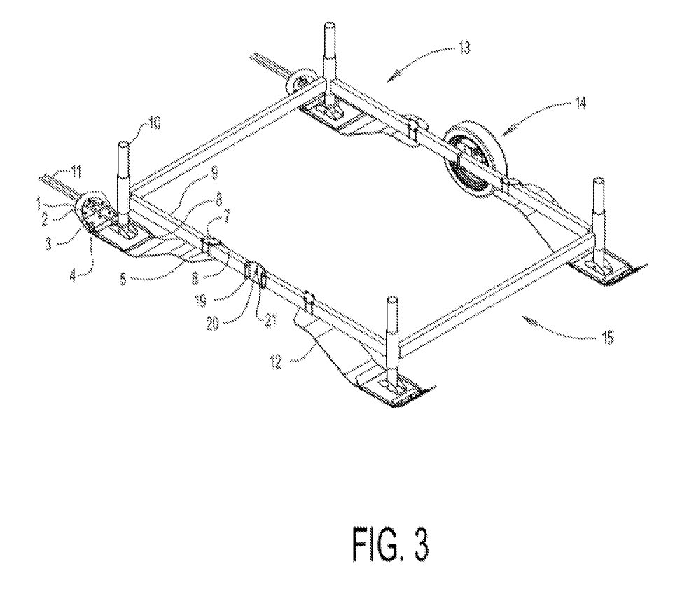

The described ski system can facilitate moving a boat lift across more rugged ground without building ramps or lifting leg pads over obstacles that sometimes tear pads off the legs. The front ski 1 can lead the direction of travel when it is used in conjunction with the tow line 11. The skis 1 on the front legs 10 can engage tow lines to follow the lines over obstacles without snagging them. The back of the front ski and front of the back ski are attached to the lower beam 9 between the front and rear lift legs 10. This can provide a continuous slide surface under each lift side for traversing obstacles without getting hung up on them. The front of the front ski 1 can attached to pad 8 along with pad extension 2. This attachment is shown being made by bolts 3 and nuts 4 which also attach the ski 1 to the extension 2 around their matching passages to accommodate tow line 11. Extension 3 can raise the end of ski 1 over various obstructions such as a washed shore line or laying post. The passage of line 11 thru the tip of ski 1 can assist in traversing horizontal ridges higher than the tip of the ski when additional lift is needed under the ski 1 to start the tip of the ski 1 over the top of the obstruction. Pad tilt limiter 17 attached by bolt 18 can maintain the ski position when crossing over a high obstacle results in pad 8 being lifted off the ground by tow line 11. The ski 1 slide surface under leg pad 8 as shown can continue beyond the pad to the attachment point of ski 1 to beam 9 by “u” bolts 5 with cap 6 and nuts 7. The ski surface is continued by the bottom surface of beam 9 to a similar attachment of ski 12 which, as shown, can extend the slide surface past the end of the boat lift frame bottom. The ski 12 can be shown as a mirrored image of ski 1 and also accommodates a tow line for towing the lift in the opposite direction. FIG. 1 shows one ski system of a plurality that could be installed under a boat lift. The typical set up would consist of a pair of ski systems at the left side and right side 13 of a boat lift having been attached to the lift frame work 15 as shown in FIG. 3. Some short lifts could use a plurality of single long skis 16 as shown in FIG. 2. Lifts could be configured with a plurality of skis being a combination of the system shown by FIG. 1 and the system shown by FIG. 2. Skis can be used with a plurality of wheels 14 shown in FIG. 3. A wheel can be attached to bracket 19. Bracket 19 may be attached with bolt 20 and nut 21 near the center of beam 9 or most anyplace else along either side of beam 9. Wheel bracket 19 can be left in place to facilitate installation and removal of wheels used for a long lift move to and from storage when wheels are not wanted on the lift for deployment into or use in the water. A cover can also be used on the ski set.

### Component Parts:

The front ski 1 can be made from flexible uv resistant hmw polyethylene sheet about ⅛ to 3/16 inch thick. The width can be similar to that of the boat-lift leg pad 8 which is about 12 inches wide. The plastic skis can be 48 to 60 inches long but may be longer or shorter. The plastic of light colored skis can have ultra-violate sunlight resistant chemicals added or a more uv resistant dark color such as black may be used or a combination thereof. The skis could be made of uhmw or other plastic or non-plastic materials preferably with a wear resistant sliding surface facing the ground. The ski end outboard from the lift can have a curved end and a slot near this end to accommodate a tow line 11. This end of the ski can have a plurality of holes about ¼ to ⅜ inch to accommodate fasteners to attach the ski to the pad 8 and/or a pad extension 2. The holes may have a counter bore relief to accommodate the bolt 3 heads. The opposite end of the ski can have holes preferably 5/16 to ½ inch in dia. to accommodate “u” bolts 5 that secure it to the lift frame 9.
Leg pad extension 2 can be made from sheet aluminum about ⅛ to 5/16″ thick and may be made from steel or other materials with appropriate adjustments to thickness.
Fastener holes in the extension 2 can match those in the ski ends. Extensions 2 can be formed to match and extend the leading edge of pad 8 and additional forming could provide a ski tip that is preferably 3 to 6 inches in height at an angle at the tip of 15° to 40°. Holes can be field drilled into the leading end of the pad if non-existent to secure the leg pad extension to the leg pad with bolts 3.
Bolts 3 are ¼ to 5/16 inch dia. elevator bolts with large dia. heads that resist pulling thru the plastic. These and addition bolts 3 through just the ski and ski extension are secured with nuts 4. Pop rivets of other fasteners could well be used as substitute fasteners for bolts 3.
“U” bolts 5 can be ¼ to ⅜ inch dia. and are long enough to accommodate the height of boat lift bottom beam 9 and plate 7. Beam 9 can vary by lift manufacturer and model.
Plate 7 can be 3/16 to 5/16 inch thick aluminum with holes to accommodate “u” bolts 5 secured by nuts 7. Steel or various materials of various thickness could be used.
Nuts 7, “u” bolts and elevator bolts can be steel or stainless for extended service as in salt water applications. Plastic, aluminum and other materials are well known to those familiar in the art.
Tow line 11 can be a flat strap as in a tie down strap, but could also be a rope, cable, chain, or other similar towing line.
Ski 12 can be or can be similar to a mirrored image of ski 1.
Ski 16 can be similar to skis 1 and 12 joined together and may be installed with or without clamp or clamps of parts 5 thru 7.
Pad tilt limiter 17 can be a tube flange mounted to lift leg 10 with bolt 18. A variety of substitutes such as straps or cables as well as extension devices like shock absorbers are widely used functional substitutes among many are well known to those familiar in the art.
Wheel bracket 19 can be formed for low extension below beam 9 to accommodate it being retained on the beam after the wheel has been removed from the bracket. It can be retained to the beam with a fastener bolt 20 and nut 21 that functions as a bent carriage bolt. The bracket 19 flange holes can mate with holes in a wheel height adjustment bracket can stays with the removable tire assembly 14.
Tire assembly 14 can be an inflatable tire-wheel assembly with anti-friction bearings or a conventional hard dock & lift tire without anti-friction bearings.

The invention can provide a continuous sliding surface under the length of the boat lift frame such that vertical surfaces in the path of suspension parts carrying the boat lift are prevented from solidly butting up against obstructions that could stop forward travel. This can be accomplished by providing a full length sliding surface under the frame to slide it over the top of the obstruction as illustrated in FIGS. 1-3. It is further improved by cooperating tow lines 11 which lift the leading tips of the sliding surface to get them started over the top of the obstruction in the first place, particularly useful with larger obstructions.

A continuous sliding surface under the length of the boat-lift frame bottom, whether consisting of a single ski surface or a continuation of cooperating ski components under the length of the frame, can improve the moving of boat lifts. The invention can be enhanced by cooperating tow lines that help position sliding surfaces in a position to start over obstructions.

To make this invention one could first make element parts including added slide surfaces along with hardware and/or adhesives used to combine and attach components to the boat-lift. The parts could be installed or included at the factory for new lifts shipped or the parts could be packed and shipped as a field installation package to be installed on existing lifts in the field, even older lifts.

The invention may be used in various ways. It may be used to retrieve the lift from the water at the end of seasonal use. Lift tow lines may be attached to a vehicle such as a tractor, car, pickup, and towed from the water to storage location. If the lift is stored near its point of use along with a dock both may be pulled from the water at the same time. Long tow straps such as 30 feet may connect the lift to the back end of a dock and allow room for the lift to position itself behind the dock as the dock is towed out of the water. Lift tow lines could be attached to a stationary cable winch mounted on a vehicle, building, tree or other anchor location. The lift can also be towed in the opposite direction in bringing it to its point of deployment near or into the water.

For the purposes of this disclosure, like reference numerals in the figures shall refer to like features unless otherwise indicated.

The above disclosure is intended to be illustrative and not exhaustive. This description will suggest many variations and alternatives to one of ordinary skill in this art. The various elements shown in the individual figures and described above may be combined or modified for combination as desired. All these alternatives and variations are intended to be included within the scope of the claims where the term “comprising” means “including, but not limited to”.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

1. A lift assembly comprising a frame work extending between a first lift side and a second lift side and a frame support system wherein a portion of the frame support system includes a ski system that extends under the frame work in the direction of travel such that a continuous sliding surface is presented to slide the frame over obstacles.

2. The lift assembly of claim 1, wherein the end of the ski toward the direction of travel engages a tow line, the tow line constructed and arranged to provide lift to the ski end when the tow line is pulled.

3. The lift assembly of claim 1, wherein a member of the frame support system at a lower position of the frame support system functions as part of the ski sliding surface in conjunction with a ski segment at each end to form a continuous surface under the lift.

4. The lift assembly of claim 3, wherein the end of the ski toward the direction of travel engages the tow line to lift the ski end over obstacles higher than the ski height which would otherwise not be able to be traversed.

5. The lift assembly of claim 1, wherein a plurality of wheels are installed.

6. The lift assembly of claim 2, wherein a plurality of wheels are installed.

7. The lift assembly of claim 3, wherein a plurality of wheels are installed.

8. The lift assembly of claim 4, wherein a plurality of wheels are installed.
